(19) United States
(12) Patent Application Publication
(10) Pub. No.: US 2013/0013278 A1
(43) Pub. Date: Jan. 10, 2013

(54) NON-INVASIVE CARDIOVASCULAR IMAGE MATCHING METHOD

(76) Inventor: Wei-Chih HU, (US)

(21) Appl. No.: 13/365,529

(22) Filed: Feb. 3, 2012

(30) Foreign Application Priority Data
Jul. 8, 2011 (TW) 100124188

(51) Int. Cl. G06G 7/48

(52) U.S. Cl. 703/11

(57) ABSTRACT

A non-invasive cardiovascular image matching method is revealed. First, a scanning unit scans a heart/blood vessel to get an image of the heart/blood vessel and sends the image to a computer. Then the computer constructs a first 3D model of the heart/blood vessel according to the image of the heart/blood vessel. Next the computer simulates systole and diastole of the heart/blood vessel according to the first 3D model. Later a measured systolic/diastolic change is compared with the simulated systolic/diastolic change by the computer so as to learn systolic/diastolic changes between the heart/blood vessel at this stage and the heart/blood vessel in normal condition.

### BACKGROUND OF THE INVENTION

1. Fields of the Invention

The present invention relates to a visceral evaluation method, especially to a non-invasive cardiovascular image matching method that compares simulated results of cardiovascular images with measured results of heart/blood vessels in motion so as to learn variations between the heart/blood vessels in normal condition and the heart/blood vessels at this moment.

2. Descriptions of Related Art

In modern society, more and more people have heart diseases due to bad health habits. Among them, there are a certain ratio of the patients have myocardial disorders. Most of medical research focuses on the treatment of the patients. However, if the disorders of the heart muscles can be detected in early stage, the treatment cost is less and the survival rate of the patients after treatment is improved. Thus the detection of myocardial disorders has become an important issue. The heart is responsible for pumping blood to all organs required in the body. Through the contraction of the left ventricle, the blood is pumped to various tissues and organs in the body while via the right ventricle, the blood collected from the tissues and organs is pumped into blood vessels in the lugs. The physiologic load and stress on the left ventricle is much greater than the right ventricle because the left ventricle needs to pump blood to most of the body while the right ventricle only fills the lungs.

In order to find out abnormal myocardial motion in early stage, a measured result of a non-invasive tool such as Echocardiography is used for pathological analysis. It is feasible to understand physical structure of the heart during the motion. In early days, a real-time dynamic image of the heart on a cutting plane can be obtained by one-dimensional M-mode technique. It requires some imaginations to create the image in the brain. Along with the fast development of the technology, the real-time 3D echocardiography that provides 3D data sets of the complete heart has been developed. By the digital image processing that avoids problems of the build-up of noises and signal distortion during processing, left ventricular contour is obtained. After 3D mesh reconstruction of the data sets, dynamic viewing and data analysis are performed so as to get left ventricle chamber cavity variations and functional parameters for function evaluation of left ventricle during systole.

Medical images can be used to analyze chronic changes in pathology. Most of patients with cardiovascular disease have abnormal myocardial motion. The cardiac contraction and relaxation information can be obtained quickly and safely by computed tomography imaging system. However, such systems are unable to provide enough information regarding regional myocardial motion. Thus, to assess regional myocardial motion according to the function of the whole left ventricular function (LV) may lead to misjudgement. For example, people with coronary artery diseases have abnormal myocardial motions due to occluded coronary artery. The changes in regional myocardial motion around the coronary artery is unable to learn exactly only by simulation of the whole myocardial motion. Neither are the coronary diseases.

In recent years, a twist angle model that simulates myocardial motion has been developed. An elliptical movement model that simulates myocardial motion also has been invented later so as to get more precise simulation results of the myocardial motion and apply the simulation results to myocardial motion evaluation. Yet slight changes in myocardial motion are still unable to be simulated and detected. For patients with coronary diseases, whether the abnormal myocardial motion is caused by the occluded coronary artery and insufficient blood flow still can't be learned in time.

Thus there is a need to provide a non-invasive cardiovascular image matching method that simulates the heart motion for evaluating the heart function in normal condition and preventing disadvantages of conventional invasive devices. By comparison between the simulated systolic/diastolic changes with the measured systolic/diastolic changes, doctor's misjudgement can be avoided and regional myocardial motion can be detected and compared.

### SUMMARY OF THE INVENTION

Therefore it is a primary object of the present invention to provide a non-invasive cardiovascular image matching method that evaluates and simulates cardiovascular function and myocardial function by three-dimensional image models. At the same time, the myocardial/vascular motion is displayed dynamically.

In order to achieve the above object, a non-invasive cardiovascular image matching method according to the present invention includes following steps. Firstly, a scanning unit scans a heart/blood vessel to get an image of the heart/blood vessel and sends the image to a computer for constructing a first 3D model of the heart/blood vessel according to the image of the heart/blood vessel. Then the computer simulates systole and diastole of the heart/blood vessel according to the first 3D model. Next a measured result of the heart/blood vessel is compared with a simulated result of the heart/blood vessel by the computer. Thus by comparison between the measured results of the heart/blood vessel and the simulated results of the heart/blood vessel in normal condition, variations between the heart/blood vessel at this moment and the heart/blood vessel in normal condition can be learned.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a flow chart of an embodiment according to the present invention;

FIG. 2 is a flow chart of an embodiment according to the present invention;

FIG. 3 is a schematic drawing showing a simulated comparison device according to the present invention.

FIG. 4 is an original 3D drawing showing a heart according to the present invention.

FIG. 5 is an adjusted 3D drawing showing a heart according to the present invention.

FIG. 6 is an adjusted 3D drawing showing a heart according to the present invention.

### DETAILED DESCRIPTION OF THE PREFERRED EMBODIMENT

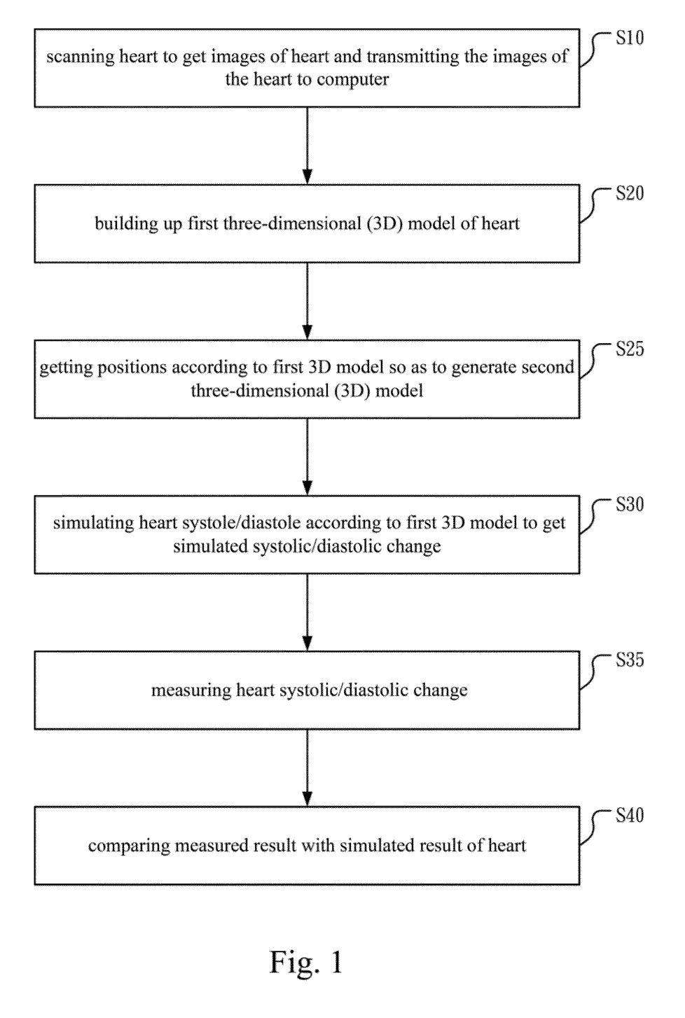

Refer to FIG. 1, a flow chart of an embodiment of the present invention is revealed. A non-invasive cardiovascular image matching method of the present invention constructs a 3-dimensional model by scanning images of hearts so as to perform simulation in normal condition and get measured results for comparison with the simulated results.

The image matching method of the present invention includes following steps:

Step S10: scanning a heart to get images of the heart and transmitting the images of the heart to a computer;

Step S20: building up a first three-dimensional (3D) model of the heart;

Step S25: getting positions according to the first 3D model so as to generate a second three-dimensional (3D) model;

Step S30: simulating heart systole/diastole according to the first 3D model to get simulated systolic/diastolic change;

Step S35: measuring heart systolic/diastolic change; and

Step S40: comparing measured result with simulated result of heart.

In the step S10, a scanning unit is used to scan a heart of a patient so as to get a heart image. The heart image is sent to a computer. In this embodiment, the heart image is a computed tomography (CT) image. Besides, the scanning unit can be an ultrasonic scanner or a Magnetic Resonance Imaging (MRI) imaging device. In the step S20, the computer constructs a first 3-dimensional model of the heart according to the heart image. The first 3-dimensional model is a 3D image model constructed based on OpenGL (Open Graphics Library) for writing applications that produce 2D and 3D computer graphics. In the step S25, the computer takes samples again according to coordinates of the first 3D model and gets positions according to one systolic/diastolic central axis of the heart. The systolic/diastolic central axis of the heart is a central axis of each ventricle used for positioning floating coordinates of heart muscle during systole and diastole. Thus a second 3D model is created.

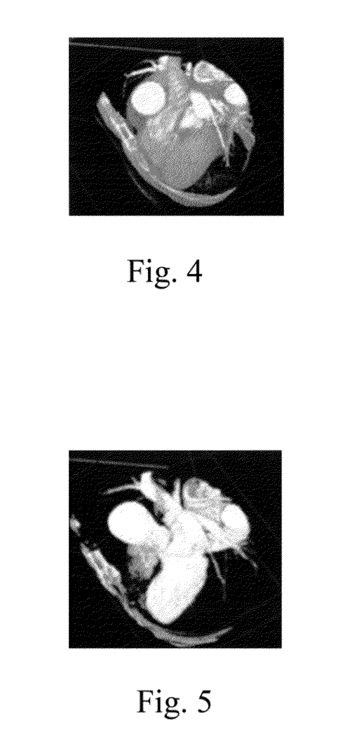

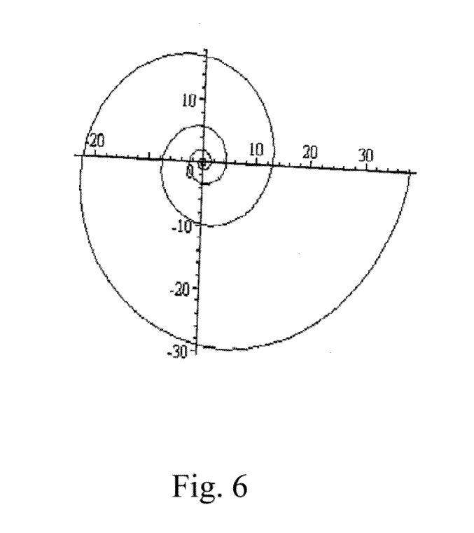

In the step S30, the computer simulates a systolic/diastolic change according to the second 3D model, a long-axis length change, a rate of change of radius, and at least one rotation angle. In this embodiment, the second 3D model is built according to the beating heart in normal condition, as images shown in FIG. 4 and FIG. 5. The FIG. 4 is an original 3D figure of the heart. The FIG. 5 is a 3D image of the left ventricle after adjustment, showing changes of the heart during heart beating processes. In the step S35, measuring systolic/diastolic changes of the patient's heart by a measuring device connected to the computer. Refer to the step S40, comparing a measured result of the heart with the simulated result obtained in the step S30 by the computer. That means the systolic/diastolic change of the patient's heart now is compared with the systolic/diastolic change of the heart in normal condition. For example, compare the heart systolic/diastolic change, blood flow change, change of heart valve displacement or change of myocardial displacement so as to learn variation between systolic/diastolic change at this stage and systolic/diastolic change in normal condition.

For making comparison, the parameters related to changes during systole/diastole of the heart such as heart systolic/diastolic change, blood flow change, change of myocardial displacement, change of heart valve displacement, etc., are used as reference data. For example, the comparison can be regional. The rate of volume change, the percent of wall motion, the percent of wall thickening are compared according to the heart systolic/diastolic change, blood flow change, change of myocardial displacement so as to learn regional myocardial function of the heart. Or the comparison is between the blood flow change and deformation of the heart. Compare the rate of volume change, peak ejection rate, peak filling rate, and change of myocardial displacement of the heart according to the systolic/diastolic change of the heart, flow rate change and change of myocardial displacement. Or the comparison is between cardiac closure and regurgitation. The rate of volume change, blood return rate and degrees of the heart valve closure of the heart are compared according to the heart systolic/diastolic change, blood flow change and change of valve displacement.

The systole and diastole of the ventricle includes ventricular end-diastole, atrial systole, ventricular isovolumetric contraction, ventricular ejection, and ventricular isovolumetric relaxation. The blood flow change of the heart is corresponding to Ejection Fraction (EF). The Ejection Fraction is defined as the difference between end-diastolic volume (EDV) and end-systolic volume (ESV) divided by end-diastolic volume (EDV). ESV is the volume of blood left in a ventricle at the end of contraction while EDV is the volume of blood left in a ventricle at the end of relaxation.

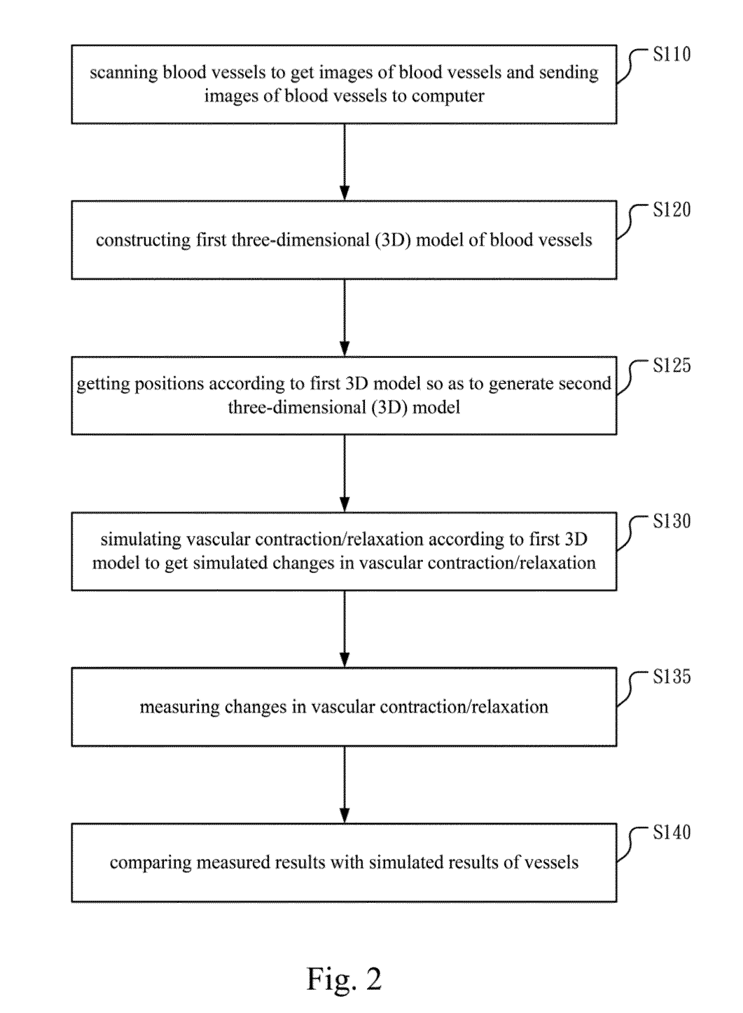

Refer to FIG. 2, a flow chart of another embodiment is disclosed. The difference between the embodiment in FIG. 1 and the embodiment in FIG. 2 is in that the target is different. The embodiment in FIG. 1 focuses on the comparison between the simulated systolic/diastolic changes and the measured systolic/diastolic changes of the heart while the embodiment in FIG. 2 is emphasized in the comparison between the simulated systolic/diastolic changes and the actual (measured) systolic/diastolic changes of blood vessels. The present invention can be applied to detect systolic/diastolic changes of blood vessels connected to the heart. The method of this embodiment includes the following steps.

Step S110: scanning blood vessels to get images of blood vessels and sending the images of blood vessels to a computer;

Step S120: constructing a first three-dimensional (3D) model of the blood vessels;

Step S125: getting positions according to a first 3D model so as to generate a second three-dimensional (3D) model;

Step S130: simulating vascular contraction/relaxation according to the first 3D model to get simulated changes in vascular contraction/relaxation;

Step S135: measuring changes in vascular contraction/relaxation; and

Step S140: comparing the measured results with the simulated results of the vessels.

The difference between this embodiment (step S110 to step S140) and the above embodiment (step S10 to step S40) is in that the targets are different. In this embodiment, the target is to get changes in contraction and relaxation of blood vessels such as great artery. The simulation and comparison focus on cyclic changes in vascular contraction/relaxation, blood flow changes, changes in vascular wall so as to learn changes in vascular contraction/relaxation between the blood vessel at this moment and the blood vessel in normal condition.

Generally, the most common heart diseases include abnormal ventricular contraction patterns, blood flow abnormality, heart valve abnormality, abnormal arterial blood flow, etc. In the step S40, the heart systolic/diastolic change is compared while in the step S140, the compared target is blood vessel connected to the heart such as artery and vein. Thus the step S40 is used to get the systolic/diastolic changes between a ventricle of the heart at this moment and the ventricle in normal condition. Similarly, the step S140 is used to learn changes in vascular contraction/relaxation between the blood vessel that connects to the heart at this moment and the blood vessel in normal condition. For example, in the step S40, the myocardial contractions of an inner wall of a ventricle are compared so as to confirm that whether the myocardial contraction of the inner wall of the ventricle is abnormal. Or the blood flow changes of the ventricle are compared so as to check heart deformation, blood flow and blood pressure caused due to blood flow of the heart. Or the valves of the ventricles are compared so as to check whether the valve closes property or not that cause regurgitation of blood. In the step S140, changes in atrial systole/diastole are compared so as to check whether the artery connected to the heart muscle is abnormal.

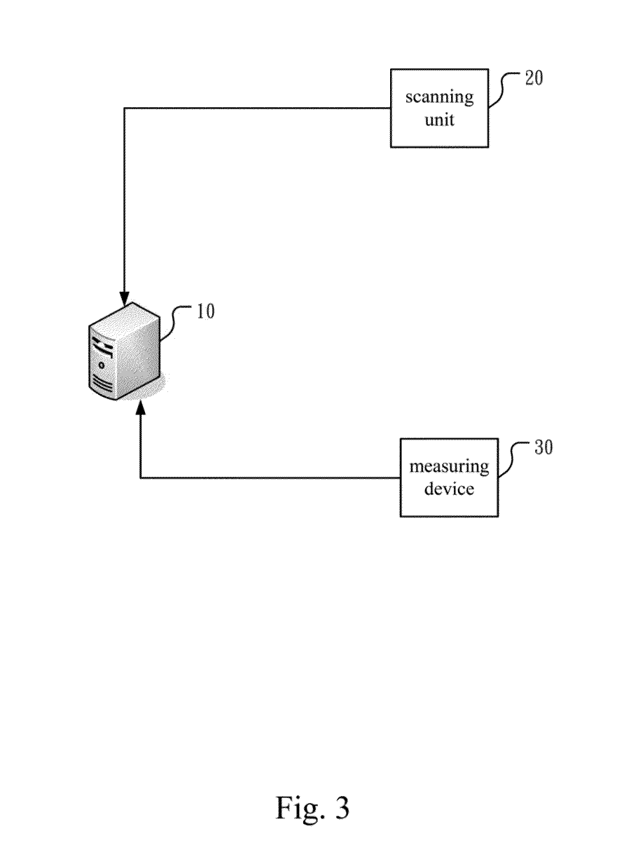

Refer to FIG. 3, a block diagram of a simulation and matching equipment of the present invention is revealed. As shown in the figure, the equipment includes a computer 10, a scanning unit 20 and a measuring device 30. The changes in systole/diastole of the heart or blood vessels at this moment and the changes in normal condition are compared.

The scanning unit 20 and the measuring device 30 are respectively connected to the computer 10. The scanning unit 20 scans the heart of the patient to get images of the heart. The scanning unit 20 can be an ultrasonic scanner, a CT scanner or a MRI imaging device. The scanned images are sent from the scanning unit 20 to the computer 10 for processing. That means the patient's heart is scanned to get images that are sent to the computer 10. According to the scanned images of the heart, the computer 10 constructs a first 3D model of a left ventricle of the heart. The first 3D model includes a plurality of meshes such as 3D triangular mesh. During heart systole/diastole, most of heart muscle moves within floating coordinates of a coordinate system. Thus the computer 10 needs to take samples again and get positions according to the first 3D model and one systolic/diastolic central axis of a ventricle of the heart so as to create a second 3D model.

For construction of the second 3D model of the heart, the computer 10 needs to get three control parameters related to the second 3D model.

The first control parameter is the distance from the mitral valve to the apex within ten timings of each ventricle of the heart. That's the long axis of each ventricle of the heart. By the information of the long axis of each ventricle of the heart, the changes in systole of the left ventricle of the heart is learned and the long axis of the left ventricle of the heart is defined as a new central axis in simulation of the second 3D model.

The second control parameter is a rotating angle of the muscle of the heart in consideration of rotation and twisting of the left ventricle of the heart.

The third control parameter is a rate of change of ventricular radius obtained by comparison of the ventricular end-diastolic radius with the ventricular end-systolic radius. The equation associated with the rate of change of radius is:

Rᵣₐₜₑ=(R_{ED}−R_{ES})/R_{ED} equation 1

wherein R is ventricular radius, Rᵣₐₜₑ is rate of change of radius, angle is the rotation angle. Get an average value of the distance between a central point of each layer and each of 930 sampling points. Thus the ventricular end-systolic radius R_{ES} and the ventricular end-diastolic radius R_{ED} are obtained so as to calculate the rate of change of radius Rᵣₐₜₑ of the ventricle.

The rotation of the second 3D model of the heart is used to simulate the ventricular beats according to an Archimedes' spiral (referring to FIG. 3). The equation of the Archimedes' spiral is the equation 2.

γ=ae^{θ cot α} equation 2

Each rotation angle θ is corresponding to a value of r. Different θ has different value of r (cot α≠0). Starting at a point of the spiral, the spiral moves inward or outward and circles the origin to form an unbounded number of circles along with unlimited increasing/decreasing of the rotation angle θ. If cot α>0, the spiral moves inward and gets closer to the origin as θ goes toward ∞. On the other hand, if cot α<0, the spiral moves outward and gets far away from the origin as θ goes toward −∞. a is a distance from the point to the origin.

While being applied to the second 3D model of the left ventricle of the heart, the systolic/diastolic change is larger when an input angle is larger. Then the rate of change of radius Rᵣₐₜₑ of the ventricle is linearly divided to each degree of the rotation angle θ. According to the above parameters, the equation corresponding to the beating of left ventricle of the heart simulated by the second 3D model is as following:

$$R = γ \times ( 1 + ( \frac{{R}_{rate}}{20} \times angle ) ) \qquad equation 3$$

The first 3D mode of the heart according to the present invention is composed by a plurality of meshes. These meshes are constructed by the computer 10 using vectors. According to the vectors, the computer 10 obtains a plurality of meshes that constitute each myocardial area. Thus the change of each myocardial area is obtained according to average normal vector of the meshes within each myocardial area while the computer 10 calculating the change of each myocardial area. That means the normal vector of the myocardial area during diastole deducts the normal vector of the myocardial area during systole so as to get change in motion of the myocardial area during systole. The computer 10 uses the change in regional myocardial motion together with the simulated results of the second 3D model to get simulated systolic/diastolic change of the heart. Moreover, the systolic/diastolic change of the heart can be measured by the measuring device 30 that measures the rate of change of the long axis, the rate of change of the radius and the rate of change of the rotation angle, and regional myocardial motion at different timing. Next the computer 10 compares the simulated systolic/diastolic changes with the measured systolic/diastolic changes so as to evaluate the condition of the heart. While evaluating the condition, the computer 10 assesses overall condition of the heart and regional myocardial motion based on data of the long axis, the rate of change of the radius and the rotation angle of each myocardial area. Therefore the present invention can make comparisons of changes of both the ventricle and the regional cardiac muscle so as to improve accuracy of the evaluation of the heart in normal condition. Moreover, the evaluation of the heart can be done quickly and safely.

In summary, a non-invasive cardiovascular image matching method of the present invention includes following steps. A scanning unit scans a heart to get images of the heart and sends the images of the heart to a computer for constructing a first 3D model. Then the computer simulates heart beats according to the first 3D model to get simulated systolic/diastolic changes. Later the computer compares the simulated systolic/diastolic changes of the heart with a measured systolic/diastolic change of the heart. At last, the computer evaluates the heart state according to a result of the comparison. In accordance with the above method, the patient's heart can be detected by an non-invasive way to learn the condition of the heart/blood vessel in motion quickly and safely. Together with the comparison of regional myocardial motion, the misjudgement can be avoided.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A non-invasive cardiovascular image matching method comprising the steps of:
scanning a heart to get an image of a heart and sending the image of the heart to a computer by a scanning unit;
constructing a first three-dimensional (3D) model of the heart by the computer according to the image of the heart;
getting positions of the first 3D model by the computer according to a systolic/diastolic central axis of the heart so as to generate a second three-dimensional model;
simulating a systolic/diastolic change of the heart according to the second 3D position, a long-axis length change, a rate of change of radius, and at least one rotation angle by the computer; the simulated systolic/diastolic change is corresponding to a normal condition of the heart; and
comparing the simulated systolic/diastolic change with a systolic/diastolic change of the heart by the computer so as to learn variations between the systolic/diastolic change and the normal condition of the heart.

2. The method as claimed in claim 1, wherein before the step of comparing the simulated systolic/diastolic change with a systolic/diastolic change of the heart, the method further includes a step of measuring the systolic/diastolic change and sending the systolic/diastolic change measured to the computer by a measuring device.

3. The method as claimed in claim 2, wherein the computer gets the measuring device measures the systolic/diastolic change according to the long-axis length change, the rate of change of radius, and the rotation angle of the heart.

4. The method as claimed in claim 3, wherein in the step of comparing the simulated systolic/diastolic change with a systolic/diastolic change of the heart, the heart is divided into at least eighteen areas according to a plurality of meshes of the first 3D model for regional comparison of the heart.

5. The method as claimed in claim 1, wherein in the step of comparing the simulated systolic/diastolic change with a systolic/diastolic change of the heart, rate of volume change, percent of wall motion, percent of wall thickening of the heart are compared according to the long-axis length change, the rate of change of radius, blood flow change, change of myocardial displacement.

6. The method as claimed in claim 1, wherein in the step of comparing the simulated systolic/diastolic change with a systolic/diastolic change of the heart, rate of volume change, peak ejection rate, peak filling rate, and change of myocardial displacement of the heart are compared according to the long-axis length change, the rate of change of radius, flow rate change and change of myocardial displacement.

7. The method as claimed in claim 1, wherein in the step of comparing the simulated systolic/diastolic change with a systolic/diastolic change of the heart, rate of volume change, blood return rate and degrees of the heart valve closure of the heart are compared according to the long-axis length change, the rate of change of radius, blood flow change and change of valve displacement.

8. The method as claimed in claim 1, wherein the scanning unit is an ultrasonic scanner, a computed tomography scanner or a Magnetic Resonance Imaging (MRI) imaging device.

9. A non-invasive cardiovascular image matching method comprising the steps of:
scanning a heart to get an image of a blood vessel and sending the image of the blood vessel to a computer by a scanning unit;
constructing a first three-dimensional (3D) model of the blood vessel by the computer according to the image of the blood vessel;
getting positions of the first 3D model by the computer device according to a systolic/diastolic central axis of the blood vessel so as to create a second three-dimensional model;
simulating a systolic/diastolic change of the blood vessel according to the second 3D position by the computer; the simulated systolic/diastolic change is corresponding to a normal condition of the blood vessel; and
comparing the simulated systolic/diastolic change with a systolic/diastolic change of the blood vessel by the computer so as to learn variations between the systolic/diastolic change and the normal condition of the blood vessel.

10. The method as claimed in claim 9, wherein before the step of comparing the simulated systolic/diastolic change with a systolic/diastolic change of the blood vessel, the method further includes a step of measuring the systolic/diastolic change and sending the systolic/diastolic change measured to the computer by a measuring device.

11. The method as claimed in claim 9, wherein in the step of comparing the simulated systolic/diastolic change with a systolic/diastolic change of the blood vessel, rate of volume change and blood flow rate of the blood vessel are compared according to the systolic/diastolic change and blood flow change of the blood vessel.

12. The method as claimed in claim 9, wherein the scanning unit is an ultrasonic scanner, a computed tomography scanner or a Magnetic Resonance Imaging (MRI) imaging device.
